(19) United States
(12) Patent Application Publication
(10) Pub. No.: US 2009/0168282 A1
(43) Pub. Date: Jul. 2, 2009

(54) ESD PROTECTION CIRCUIT

(76) Inventors: Kun-Tai Wu, Hsinchu City (TW); Ching-Jung Yang, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/337,589

(22) Filed: Dec. 17, 2008

(30) Foreign Application Priority Data
Dec. 28, 2007 (TW) 096150867

(51) Int. Cl. H02H 9/04

(52) U.S. Cl. 361/56

(57) ABSTRACT

An ESD protection circuit includes: a voltage decreasing module, coupled between a first voltage level and a second voltage level, wherein the first voltage level is higher than the second voltage level; a gate trigger switch, coupled between the first voltage level and the second voltage level; and a detection circuit, coupled to the gate trigger switch, for detecting an ESD event to control the gate trigger switch.

### BACKGROUND OF THE INVENTION

1. Field of the Invention

The present invention relates to an ESD (Electrostatic Discharge) protection circuit, and particularly relates to an ESD protection circuit with high holding voltage.

2. Description of the Prior Art

FIG. 1 illustrates a prior art ESD protection circuit 100. As shown in FIG. 1, the ESD protection circuit 100 includes a detection circuit 101 and an N type MOS (Metal Oxide Semiconductor) transistor 103. The detection circuit 101 detects if an ESD event occurs in order to control the N type MOS transistor 103, which serves as a switch. Normally, the detection circuit 101 includes a circuit consisting of capacitors and resistors, and utilizes the delay function of the resistors and capacitors for controlling the N type MOS transistor 103 according to the ESD event.

When an ESD event occurs, however, such a structure will cause a holding voltage of the N type MOS transistor 103 to be lower than V_{DD}, which may cause latch-up of the N type MOS transistor 103.

### SUMMARY OF THE INVENTION

One objective of the present invention is therefore to provide an ESD protection circuit including a voltage decreasing module to avoid the latch-up issue for at least a switch in an ESD protection circuit.

One embodiment of the present invention discloses an ESD protection circuit, comprising: a voltage decreasing module, coupled between a first voltage level and a second voltage level, wherein the first voltage level is higher than the second voltage level; a gate trigger switch, coupled between the first voltage level and the second voltage level; and a detection circuit, coupled to the gate trigger switch, for detecting an ESD event to control the gate trigger switch.

The gate trigger switch can be a first P type MOS transistor. In this case, the detection circuit includes the following devices. A capacitor includes a first terminal and a second terminal, wherein the first terminal is coupled to the first voltage level and the gate trigger switch. A second P type MOS transistor includes: a source terminal coupled to the capacitor, the first voltage level and the gate trigger switch; a drain terminal coupled to a gate terminal of the first P type MOS transistor; and a gate terminal, coupled to the second terminal of the capacitor. An N type MOS transistor includes: a drain terminal, coupled to a drain terminal of the second P type MOS transistor; a source terminal coupled to the second voltage level and the voltage decreasing module; and a gate terminal, coupled to the second terminal of the capacitor and the gate terminal of the second P type MOS transistor. A resistor includes a first terminal and a second terminal, wherein the first terminal of the resistor is coupled to the second terminal of the capacitor, and gate terminals of the N type MOS transistor and the second P type MOS transistor, where the second terminal of the resistor is coupled to a source terminal of the N type MOS transistor and the voltage decreasing module.

The gate trigger switch can also be an N type MOS transistor. In this case, the detection circuit includes the following devices. A resistor includes a first terminal and a second terminal, wherein the first terminal is coupled between the first voltage level and the voltage decreasing module. A P type MOS transistor includes: a source terminal, coupled to the first terminal of the resistor, the first voltage level and the voltage decreasing module; a drain terminal, coupled to a gate terminal of the first N type MOS transistor; and a gate terminal, coupled to the second terminal of the transistor. A second N type MOS transistor includes: a drain terminal, coupled to a drain terminal of the P type MOS transistor; a source terminal, coupled to the second voltage level; and a gate terminal, coupled to the second terminal of the resistor and the gate terminal of the P type MOS transistor. A capacitor includes a first terminal and a second terminal, wherein the first terminal of the capacitor is coupled to the second terminal of the resistor, and gate terminals of the second N type MOS transistor and the P type MOS transistor, where the second terminal of the capacitor is coupled to sources terminals of the second N type MOS transistor and the first type MOS transistor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a prior art ESD protection circuit.

FIG. 2 illustrates an ESD protection circuit according to a first embodiment of the present invention.

FIG. 3 illustrates the voltage-current relation of an ESD protection circuit according to an embodiment of the present invention.

FIG. 4 illustrates an ESD protection circuit according to a second embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

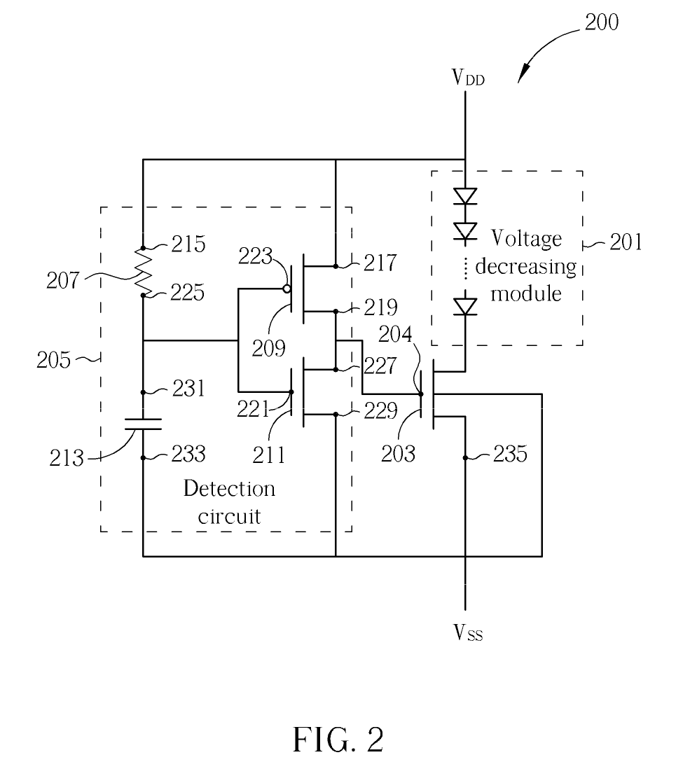

FIG. 2 illustrates an ESD protection circuit 200 according to a first embodiment of the present invention. As shown in FIG. 2, the ESD protection circuit 200 includes a voltage decreasing module 201, a gate trigger switch 203 and a detection circuit 205. In this embodiment, the voltage decreasing module 201 is provided between a gate trigger switch 203 and a first voltage level V_{DD}. The first voltage level V_{DD} (i.e. a system voltage of the ESD protection circuit 200) is higher than a first voltage level Vss, which can be a ground voltage level.

In the embodiment shown in FIG. 2, the voltage decreasing module 201 includes a plurality of diodes, but the voltage decreasing module 201 can also comprise other devices besides or instead of diodes. The gate trigger circuit 203 is an N type MOS transistor having: a gate terminal 204 coupled to the second voltage source Vss and the detection circuit 205; and a source terminal 235 coupled to the second voltage source Vss. It should be noted that other gate trigger switches having the same functions also belong within the scope of the present invention. The detection circuit 205 includes a resistor 207, a P type MOS transistor 209, an N type MOS transistor 211, and a capacitor 213. The resistor 207 includes a first terminal 215 and a second terminal 225, wherein the first terminal 215 is coupled between the first voltage level V_{DD} and the voltage decreasing module 201. The P type MOS transistor 209 has: a source terminal 217 coupled to a first terminal 215 of the resistor 207, the first voltage level V_{DD} and the voltage decreasing module 201; a drain terminal 219 coupled to a gate terminal 204 of the gate trigger switch 203; and a gate terminal 223 coupled to a second terminal 225 of the resistor 207.

The N type MOS transistor 211 has: a drain terminal 227 coupled to a drain terminal 219 of the P type MOS transistor 209 and a gate terminal 204 of the gate trigger switch 203; a source terminal 229 coupled to the second voltage level Vss and a source terminal 235 of the gate trigger switch 203; and a gate terminal 221 coupled to a second terminal 225 of the resistor 207 and a gate terminal of the P type MOS transistor 209. The capacitor 213 includes: a first terminal 231, coupled to a second terminal 225 of the resistor 207, and gate terminals 221, 223 of the N type MOS transistor 211 and the P type MOS transistor 209; and a second terminal 233 coupled to the source terminal 229, 235 of the N type MOS transistor 211 and the gate trigger switch 203. It should be noted that the detection circuit 205 illustrated in FIG. 2 is only an example and is not meant to limit the scope of the present invention; detection circuits with other structures can also be applied to embodiments of the present invention. In this embodiment, the voltage decreasing module 201 and the gate trigger switch 235 forms a main electronic discharging path. The detection circuit 205 controls the gate trigger switch 203 to be conductive when an ESD event occurs. The ESD event means that a large current or a high voltage occurs, as known by persons skilled in the art.

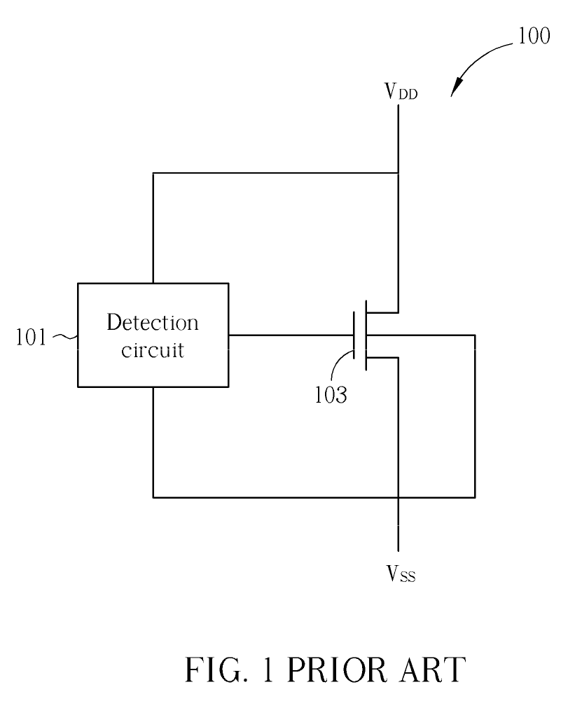

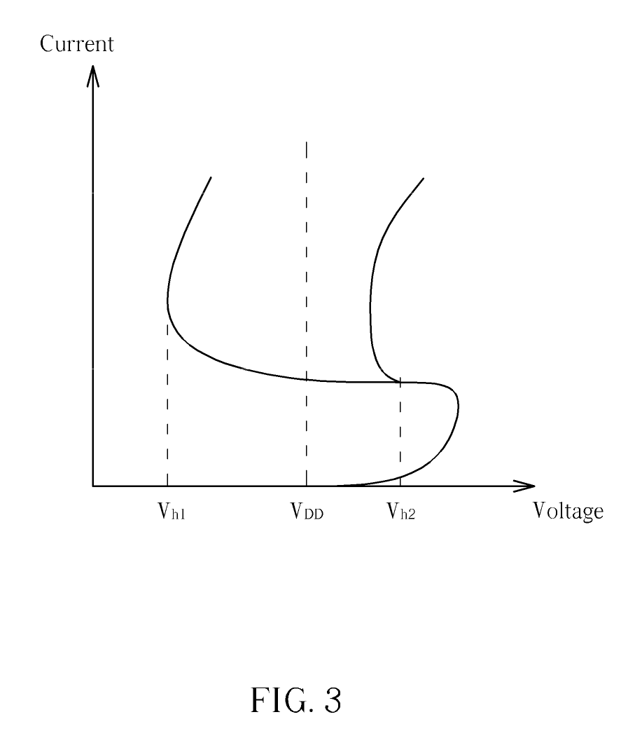

FIG. 3 illustrates the voltage-current relation of an ESD protection circuit according to an embodiment of the present invention. As shown in FIG. 3, the holding voltage of a prior art ESD protection circuit is Vₕ₁ when an ESD event occurs. Vₕ₁ is smaller than the first voltage level V_{DD}, thus the switch may latch. According to the embodiment shown in FIG. 2, however, the holding voltage can be increased to Vₕ₂ larger than the first voltage level V_{DD}, thus the switch will not latch and the latch issue illustrated in FIG. 1 can be avoided.

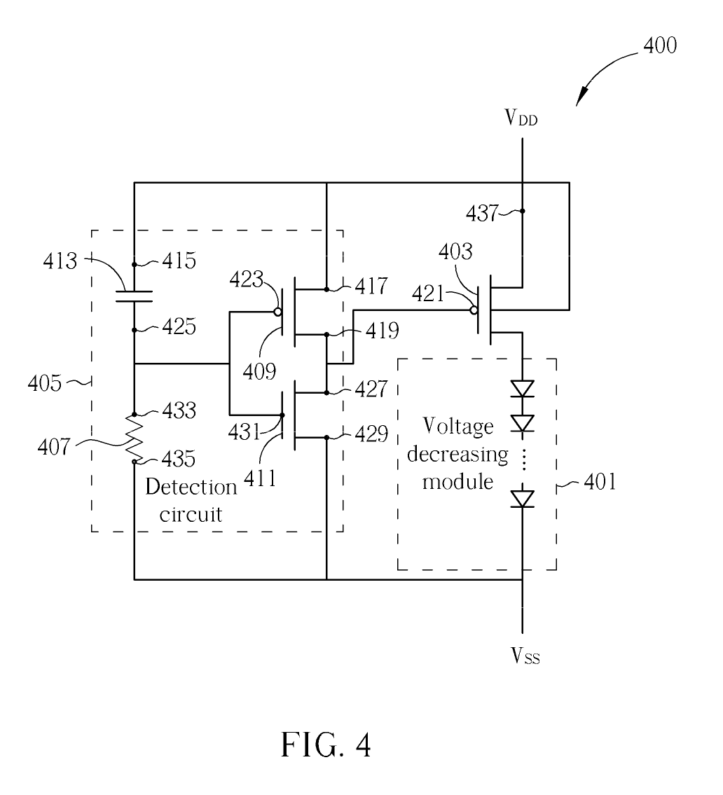

FIG. 4 illustrates an ESD protection circuit 400 according to a second embodiment of the present invention. In the ESD protection circuit 400, the voltage decreasing module 401 is provided between the gate trigger switch 403 and the second voltage level Vss. The gate trigger switch 403 is a P type MOS transistor. It should be noted that other gate trigger switches with the same function also belong within the scope of the present invention. The detection circuit 405 and the detection circuit 205 both include a resistor 407, a P type MOS transistor 409, an N type MOS transistor 411 and a capacitor 413. The capacitor 413 includes a first terminal 415 and a second terminal 425, and the first terminal 415 is coupled to the first voltage level V_{DD} and the gate trigger switch 403. The P MOS transistor 409 includes: a source terminal 417 coupled to a first terminal 415 of the capacitor 413, the first voltage level V_{DD} and a source terminal 437 of the gate trigger switch 403; a drain terminal 419 coupled to a gate terminal 421 of the gate trigger switch 403; and a gate terminal 423 coupled to a second terminal 425 of the capacitor 413.

The N type MOS transistor 411 includes: a drain terminal 427, coupled to a drain terminal 427 of the P type MOS transistor 409; a source terminal 429 coupled to the second voltage level Vss and the voltage decreasing module 401; and a gate terminal 431 coupled to the second terminal 425 of the capacitor 413 and the gate terminal 423 of the P type MOS transistor 409. The resistor 407 includes a first terminal 433 and a second terminal 435, wherein the first terminal 433 of the resistor 407 is coupled to the second terminal 425 of the capacitor 413, and gate terminals 423, 431 of the N type MOS transistor 411 and the second P type MOS transistor 409. The second terminal 435 of the resistor 407 is coupled to a source terminal 429 of the N type MOS transistor 411 and the voltage decreasing module 401.

Compared with the embodiment shown in FIG. 2, the voltage decreasing module in FIG. 4 is provided at a different location from that of FIG. 2, but the same objective of the embodiment shown in FIG. 2 can still be reached. Similarly, the voltage dropping 401 shown in FIG. 4 can include different devices and the detection 405 can include different structures.

Via the above-mentioned structures, the holding voltage of the ESD protection circuit is lower than VDD, such that the problem of the prior art can be avoided. Furthermore, the gate trigger switch includes the advantages of high input resistance, high speed conductance, and superior conductance characteristics, and is thus easy to be controlled.

Those skilled in the art will readily observe that numerous modifications and alterations of the device and method may be made while retaining the teachings of the invention.

What is claimed is:

1. An ESD protection circuit, comprising:
a voltage decreasing module, coupled between a first voltage level and a second voltage level, wherein the first voltage level is higher than the second voltage level;
a gate trigger switch, coupled between the first voltage level and the second voltage level; and
a detection circuit, coupled to the gate trigger switch, for detecting an ESD event to control the gate trigger switch.

2. The ESD protection circuit of claim 1, wherein the voltage decreasing module keeps a holding voltage of the ESD protection circuit higher than the first voltage level.

3. The ESD protection circuit of claim 1, wherein the voltage decreasing module includes at least one diode.

4. The ESD protection circuit of claim 1, wherein the voltage decreasing module is provided between the gate trigger switch and the second voltage level.

5. The ESD protection circuit of claim 4, wherein the gate trigger switch is a first P type MOS transistor.

6. The ESD protection circuit of claim 5, wherein the detection circuit includes:
a capacitor, including a first terminal and a second terminal, wherein the first terminal is coupled to the first voltage level and the gate trigger switch;
a second P type MOS transistor, including:
a source terminal coupled to the capacitor, the first voltage level and the gate trigger switch;
a drain terminal coupled to a gate terminal of the first P type MOS transistor; and
a gate terminal, coupled to the second terminal of the capacitor;
an N type MOS transistor, including:
a drain terminal, coupled to a drain terminal of the second P type MOS transistor;
a source terminal coupled to the second voltage level and the voltage decreasing module; and
a gate terminal, coupled to the second terminal of the capacitor and the gate terminal of the second P type MOS transistor; and
a resistor, including a first terminal and a second terminal, wherein the first terminal of the resistor is coupled to the second terminal of the capacitor, and gate terminals of the N type MOS transistor and the second P type MOS transistor, where the second terminal of the resistor is coupled to a source terminal of the N type MOS transistor and the voltage decreasing module.

7. The ESD protection circuit of claim 1, wherein the voltage decreasing module is provided between the gate trigger switch and the first voltage level.

8. The ESD protection circuit of claim 7, wherein the gate trigger switch is a first N type MOS transistor.

9. The ESD protection circuit of claim 8, wherein the detection circuit includes:
a resistor, including a first terminal and a second terminal, wherein the first terminal is coupled between the first voltage level and the voltage decreasing module;
a P type MOS transistor, including:
a source terminal, coupled to the first terminal of the resistor, the first voltage level and the voltage decreasing module;
a drain terminal, coupled to a gate terminal of the first N type MOS transistor; and
a gate terminal, coupled to the second terminal of the transistor;
a second N type MOS transistor, including:
a drain terminal, coupled to a drain terminal of the P type MOS transistor;
a source terminal, coupled to the second voltage level; and
a gate terminal, coupled to the second terminal of the resistor and the gate terminal of the P type MOS transistor; and
a capacitor, including a first terminal and a second terminal, wherein the first terminal of the capacitor is coupled to the second terminal of the resistor, and gate terminals of the second N type MOS transistor and the P type MOS transistor, where the second terminal of the capacitor is coupled to source terminals of the second N type MOS transistor and the first N type MOS transistor.

10. The ESD protection circuit of claim 1, wherein the second voltage level is a ground voltage level, and the second voltage level is a system voltage of the ESD protection circuit.
